(19) United States
(12) Patent Application Publication
(10) Pub. No.: US 2009/0111004 A1
(43) Pub. Date: Apr. 30, 2009

(54) RECHARGEABLE BATTERY

(75) Inventors: Youngcheol JANG, Yongin-si (KR); Kyungwon Seo, Yongin-si (KR); Jeongdeok Byun, Yongin-si (KR); Eunok Kwak, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/133,655

(22) Filed: Jun. 5, 2008

(30) Foreign Application Priority Data
Oct. 29, 2007 (KR) 2007-109201

(51) Int. Cl. H01M 2/00

(52) U.S. Cl. 429/61

(57) ABSTRACT

A rechargeable battery includes: a bare cell; a protection circuit board installed on an upper surface of the bare cell; and a lead plate to connect the protection circuit board with the bare cell, wherein the lead plate includes a substrate fixing part fixed to the protection circuit board, a bare cell fixing part fixed to the bare cell, and a connection part to connect the substrate fixing part with the bare cell fixing part, the lead plate being installed such that the connection part is disposed between the protection circuit board and the upper surface of the bare cell. A welding strength is improved when the lead plate connecting the bare cell with the protection circuit board is installed, thereby prominently reducing defects in manufacturing packs and modules.

### CROSS-REFERENCE TO RELATED APPLICATION

This application claims the benefit of Korean Application No. 2007-109201 filed on Oct. 29, 2007 in the Korean Intellectual Property Office, the disclosure of which is incorporated herein by reference.

### BACKGROUND OF THE INVENTION

1. Field of the Invention

Aspects of the present invention relate to a rechargeable battery, and more particularly, to a rechargeable battery which can improve performance and reliability of the battery by improving its assembly structure.

2. Description of the Related Art

Generally, a rechargeable battery is a battery in which a voltage potential may be reestablished after having depleted the previous voltage potential stored therein while a disposable battery is not rechargeable. The rechargeable battery has been widely used in the fields of the advanced electronic devices, such as in cellular phones, notebook computers, and camcorders. Particularly, a lithium rechargeable battery has an operation voltage of 3.6V, which is three times higher than a Ni—Cd battery or a Ni—H battery, and has a high energy density per unit weight. Therefore, the lithium-ion battery is being rapidly developed.

The lithium rechargeable battery includes a bare cell and a protection circuit module (PCM), which electrically protects operation of the bare cell. The bare cell is generally comprised of an electrode assembly including a cathode plate, an anode plate, and a separator disposed therebetween, a can to contain the electrode assembly and an electrolytic solution, and a cap assembly to seal an opening part of the can.

Methods of fixing the PCM to the bare cell include a molding method using injected melted resin and an assembling method using an injection molded case. The method of fixing the protect circuit module to the bare cell by molding the melted resin is performed at a high temperature which produces undesirable effects on various elements included in the protect circuit module. Further, there is a disadvantage that it is difficult to accurately and precisely form a molding resin at an exact position on an upper surface of the bare cell, thereby increasing defects.

On the other hand, the method of fixing the PCM to the bare cell by the injection molded case have advantages in that the method does not affect the elements of the protect circuit module, it is possible to accurately assemble the PCM to an exact position in the bare cell, and the assembling process is simple.

A lead plate made of conductive material is provided at a cap plate of the bare cell so as to electrically couple a protection circuit board to the bare cell. However, the conventional lead plate is welded without being in contact with the upper surface of the cap plate. As such, the force exerted on the protection circuit board by the lead plate is not uniform. When the lead plate is welded without being in contact with the upper surface of the cap plate as above, a gap is generated between the lead plate and the cap plate, thereby causing weld defects. Accordingly, a welding strength of the lead plate fixed to the upper surface of the cap plate is decreased, thereby lowering quality of products.

### SUMMARY OF THE INVENTION

According to aspects of the present invention, a rechargeable battery that can improve a welding strength of a lead plate that connects a protection circuit board with a bare cell is provided.

According to an aspect of the present invention, there is provided a rechargeable battery, which includes: a bare cell; a protection circuit board disposed on an upper surface of the bare cell; and a lead plate to connect the protection circuit board with the bare cell, wherein the lead plate includes a substrate fixing part fixed to the protection circuit board, a bare cell fixing part fixed to the bare cell and a connection part to connect the substrate fixing part and the bare cell fixing part, the lead plate being installed such that the connection part is disposed between the protection circuit board and the upper surface of the bare cell.

According to aspects of the present invention, the substrate fixing part may be an upper end part of the lead plate that is folded in parallel with the protection circuit board and fixed to a lower surface of the protection circuit board, and the bare cell fixing part may be a lower end part that is folded in parallel with the upper surface of the bare cell and fixed to the upper surface of the bare cell.

According to aspects of the present invention, the substrate fixing part and bare cell fixing part of the lead plate may be folded in the same direction about the connection part. The bare cell fixing part is formed longer than the substrate fixing part.

According to aspects of the present invention, the substrate fixing part and bare cell fixing part of the lead plate may be folded in opposite directions about the connection part. The connection part may be provided at both ends of the protection circuit board.

According to aspects of the present invention, the bare cell fixing part may be fixed to the upper surface of the bare cell by laser welding.

According to aspects of the present invention, the lead plate may be made of nickel or nickel alloy.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a rechargeable battery according to aspects of the present invention;

FIG. 2 is an exploded perspective view illustrating a bare cell and a protection circuit board according to an exemplary embodiment of the present invention;

FIG. 3 is a front view illustrating a state that a lead plate according to an exemplary embodiment of the present invention is applied; and

FIG. 4 is a front view illustrating a rechargeable battery according to another exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

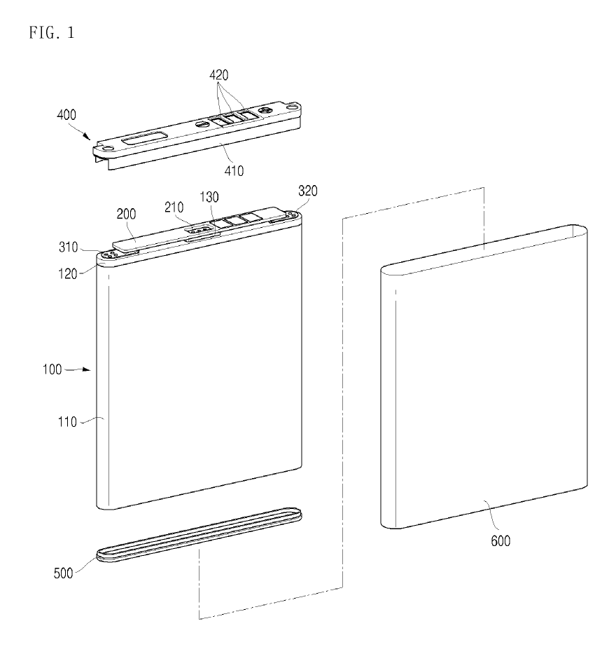

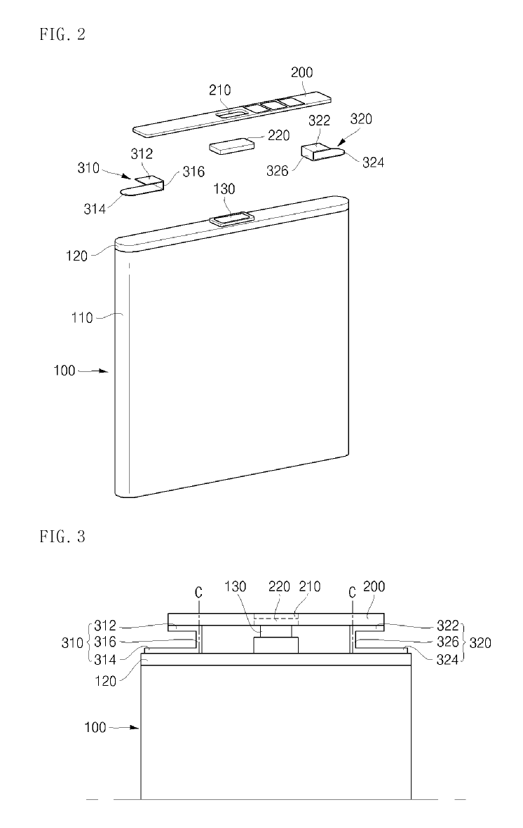

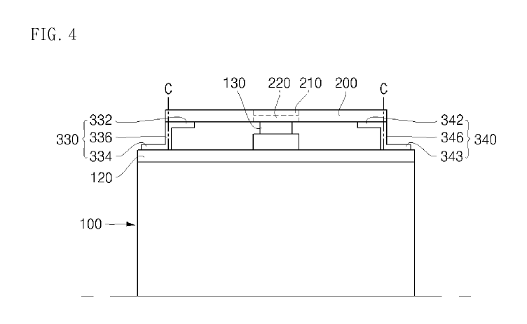

FIG. 1 is an exploded perspective view illustrating a rechargeable battery according to aspects of the present invention. FIG. 2 is an exploded perspective view illustrating a bare cell and a protection circuit board of the rechargeable battery. FIG. 3 is a front view illustrating the rechargeable battery.

Referring to FIGS. 1 to 3, the rechargeable battery includes a rechargeable bare cell 100, a protection circuit board 200 installed on an upper surface of the bare cell 100, lead plates 310 and 320 disposed between the protection circuit board 200 and bare cell 100 so as to electrically couple them, an upper cover 400 installed so as to cover the upper surface of the bare cell 100 while surrounding the protection circuit board 200 and fix the protection circuit board 200 to an upper part of the bare cell, a lower cover 500 fixed to a lower surface of the bare cell 100, and a label sheet 600 wound about the bare cell 100.

The bare cell 100 includes an electrode assembly (not shown) comprised of a cathode plate, a separator, and an anode plate, a can 110 to contain the electrode assembly and an electrolytic solution, a cap assembly (not shown) including a cap plate 120 sealing an opening part of the can 110, and an electrode terminal 130 that extends through the cap plate 120 so as to connect the electrode assembly to an electrical terminal (not shown) of the protection circuit board 200.

A hole 210 is formed in the protection circuit board 200 to correspond to a position where the electrode terminal 130 of the bare cell 100 is provided. The electrode terminal 130 is connected to an electrical terminal 220 installed in parallel with the cap plate 120 by laser welding through the hole 210 of the protection circuit board 200.

Lead plates 310 and 320 are installed at both ends of the cap plate 120 of the bare cell 100. The lead plates 310 and 320 electrically couple the protection circuit board 200 to the bare cell 100.

One of the lead plates 310 and 320 is electrically coupled to the electrode terminal 130 and an electrical terminal of the protection circuit board 200 having an opposite polarity of the electrode terminal 130. That is, when the electrode terminal 130 of the bare cell 100 is connected to the electrical terminal 220 with a negative polarity, the electrical terminal of the protection circuit board 200 is connected with a positive polarity. Here, the polarities may be exchanged.

With reference to FIG. 2, the lead plates 310 and 320 include substrate fixing parts 312 and 322, bare cell fixing parts 314 and 324, and connection parts 316 and 326, respectively. The substrate fixing parts 312 and 322 are formed by folding upper end parts of the lead plates 310 and 320 in parallel with the protection circuit board 200 and are welded to the protection circuit board 200. The bare cell fixing parts 314 and 324 are formed by folding lower end parts of the lead plates 310 and 320 in parallel with the bare cell 100 and are welded to the upper surface of the bare cell 100, that is, the upper surface of the cap plate 120. The connection parts 316 and 326 are formed so as to connect the substrate fixing parts 312 and 322 with the bare cell fixing parts 314 and 324. Here, the bare cell fixing parts 314 and 324 are laser-welded to the upper surface of the cap plate 120. The lead plates 310 and 320 may be made of nickel or nickel alloy or any conductive material.

In the lead plates 310 and 320, the connection parts 316 and 326 connecting the substrate fixing parts 312 and 322 with the bare cell fixing parts 314 and 324 supporting the weight of the protection circuit board 200 at a center C as illustrated in FIG. 3. Accordingly, when the connection parts 316 and 326 are disposed toward the inside of the protection circuit board 200, the bare cell fixing parts 314 and 324 do not become loose from the upper surface of the cap plate cap plate 120 while the protection circuit board 200 is supported by the substrate fixing parts 312 and 322.

On the contrary, when the connection parts 316 and 326 of the lead plates 310 and 320 are disposed toward the outside of the protection circuit board 200, the center C is departed from the protection circuit board 200. Accordingly, the bare cell fixing parts 314 and 324 become loose from the upper surface of the cap plate cap plate 120 while the protection circuit board 200 is supported by the substrate fixing parts 312 and 322. Thus, a weld defect is generated because the bare cell fixing parts 314 and 324 are welded such that the bare cell fixing parts 314 and 324 are spaced from the cap plate 120.

The connection parts 316 and 326 of the lead plates 310 and 320 are disposed toward the inside of the protection circuit board 200 (i.e., the connection parts 316 and 326 are disposed away from a periphery of the bare cell 100) and simultaneously the bare cell fixing parts 314 and 324 of the lead plates 310 and 320 are disposed toward the outside of the protection circuit board 200 (i.e., the connection parts 316 and 326 are disposed toward the periphery of the bare cell 100).

The substrate fixing parts 312 and 322 of the lead plates 310 and 320 are welded to lower surfaces of both ends of the protection circuit board 200. The connection parts 316 and 326 are located toward the inside of the protection circuit board 200, and the bare cell fixing parts 314 and 324 are formed so as to be exposed to the outside of the protection circuit board 200 (i.e., the bare cell fixing parts 314 and 324 extend toward the periphery of the bare cell 100 further than the protection circuit board 200). In the present embodiment, the substrate fixing parts 312 and 322 and the bare cell fixing parts 314 and 324 are folded in the same direction about the connection parts 316 and 326, and the bare cell fixing parts 314 and 324 are formed longer than the substrate fixing parts 312 and 322.

According to the embodiment that is constructed as described above, the connection parts 316 and 326 are located toward the inside of the protection circuit board 200 so as to stably support the protection circuit board 200, and the bare cell fixing parts 314 and 324 contact the upper surface of the cap plate 120. In addition, the bare cell fixing parts 314 and 324 extend toward the outside of the protection circuit board 200 (i.e., toward the periphery of the bare cell 100) to provide a space in which welding can be performed at the upper part of the lead plates 310 and 320. Thus, welding of the bare cell fixing parts 314 and 324 can be stably and smoothly performed.

FIG. 4 is a front view illustrating a rechargeable battery according to another exemplary embodiment of the present invention. Referring to FIG. 4, the rechargeable battery includes a rechargeable bare cell 100, a protection circuit board 200 disposed on an upper surface of the bare cell 100, and lead plates 330 and 340 disposed between the protection circuit board 200 and the bare cell 100 so as to electrically couple the protection circuit board 200 and the bare cell 100. The construction of the bare cell 100 and the protection circuit board 200 are the same as described above except for the lead plates 330 and 340.

In the current embodiment, the lead plates 330 and 340 include substrate fixing parts 332 and 342, bare cell fixing parts 334 and 344, and connection parts 336 and 346, respectively.

In the lead plates 330 and 340, the substrate fixing parts 332 and 342 and the bare cell fixing parts 334 and 344 are folded in opposite directions to each other about the connection parts 336 and 346. In addition, the connection parts 336 and 346 are located at positions corresponding to both ends of the protection circuit board 200.

According to the current embodiment that is constructed as described above, the connection parts 336 and 346 of the lead plates 330 and 340 that support the protection circuit board 200 are located at the both ends of the protection circuit board 200. Accordingly, the connection parts 336 and 346 provide centers C on which the weight of the protection circuit board 200 is supported. The lead plates 330 and 340 are in contact with both the protection circuit board 200 and the upper surface of the cap plate 120. In addition, because the bare cell fixing parts 334 and 344 are folded in opposite directions with respect to the substrate fixing parts 332 and 342, the bare cell fixing parts 334 and 344 are exposed toward the outside of the protection circuit board 200 (i.e., toward the periphery of the bare cell 100). Thus, an upper space for welding is provided.

As described above, the bare cell fixing parts 334 and 344 of the lead plates 330 and 340 do not become loose from the cap plate 120 but remain in contact therewith. Further, the bare cell fixing parts 334 and 344 are exposed so as to be welded at their upper parts. Thus, the welding process can be easily performed.

In the embodiments as described above, the rechargeable battery includes a protection circuit board covering and fixed to the upper part of the bare cell by the case. However, the embodiments can be applied to the case where the upper part of the bare cell is formed of resin material by the injecting of melted resin.

As described above, the rechargeable battery according to aspects of the present invention produces the following and/or other effects: First, a welding strength is improved when the lead plate connecting the bare cell with the protection circuit board is installed, thereby prominently reducing defects in manufacturing packs and modules. Second, the welding process can be performed under the condition that the lead plate is stably and uniformly contacted to the upper surface of the cap plate, thereby preventing weld defects. Third, the lead plate is in contact with the upper surface of the cap plate so as to be suitable for providing a welding space, thereby allowing the welding process to be easily performed.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rechargeable battery, comprising:
a bare cell;
a protection circuit board disposed on an upper surface of the bare cell; and
a lead plate to connect the protection circuit board with the bare cell, wherein the lead plate comprises:
a substrate fixing part fixed to the protection circuit board,
a bare cell fixing part fixed to the bare cell, and
a connection part to connect the substrate fixing part and the bare cell fixing part,
wherein the lead plate is disposed such that the connection part is between the protection circuit board and the upper surface of the bare cell.

2. The rechargeable battery of claim 1, wherein the substrate fixing part is an upper end part of the lead plate that is folded in parallel with the protection circuit board and fixed to a lower surface of the protection circuit board, and the bare cell fixing part is a lower end part that is folded in parallel with the upper surface of the bare cell and fixed to the upper surface of the bare cell.

3. The rechargeable battery of claim 2, wherein the substrate fixing part and the bare cell fixing part of the lead plate are folded in a same direction about the connection part.

4. The rechargeable battery of claim 3, wherein the bare cell fixing part is formed longer than the substrate fixing part.

5. The rechargeable battery of claim 3, wherein the substrate fixing part and the bare cell fixing part are disposed toward a periphery of the bare cell, and the connection part is disposed toward a center of the bare cell.

6. The rechargeable battery of claim 3, wherein the protection circuit board has a generally rectangular shape, and an end of the substrate fixing part aligns with an end of the protection circuit board.

7. The rechargeable battery of claim 2, wherein the substrate fixing part and bare cell fixing part of the lead plate are folded in opposite directions about the connection part.

8. The rechargeable battery of claim 7, wherein the protection circuit board has a generally rectangular shape, and the connection part is provided at one end of the protection circuit board, and another connection part is provided at an other end of the protection circuit board.

9. The rechargeable battery of claim 8, wherein the connection parts align with the ends of the protection circuit board.

10. The rechargeable battery of claim 7, wherein the substrate fixing part is disposed toward a center of the bare cell, and the bare cell fixing part is disposed toward a periphery of the bare cell.

11. The rechargeable battery of claim 1, wherein the bare cell fixing part is laser-welded to the upper surface of the bare cell.

12. The rechargeable battery of claim 1, wherein the lead plate is made of nickel or nickel alloy.

13. The rechargeable battery of claim 2, wherein the protection circuit board and the upper surface of the bare cell are parallel.

14. A rechargeable battery, comprising:
a bare cell having a generally rectangular prismatic shape;
a protection circuit board having a generally rectangular shape disposed on an upper surface of the bare cell; and
a lead plate disposed at each end of the generally rectangular protection circuit board to connect the protection circuit board with the bare cell,
wherein each lead plate comprises:
a substrate fixing part fixed to the protection circuit board,
a bare cell fixing part fixed to the bare cell, and
a connection part to connect the substrate fixing part and the bare cell fixing part,
wherein the substrate fixing part and the bare cell fixing part are disposed in a same direction away from the connection part, and the substrate fixing part and the bare cell fixing part are disposed toward a periphery of the bare cell,
wherein each lead plate is disposed such that the connection parts are between the protection circuit board and the upper surface of the bare cell.

15. The rechargeable battery of claim 14, wherein the upper surface of the bare cell comprises a cap plate to electrically couple the protection circuit board to the bare cell.

16. The rechargeable battery of claim 14, wherein an end disposed away from the connection part of each substrate fixing part is disposed to align respectively with the each end of the generally rectangular protection circuit board.

17. A rechargeable battery, comprising:
a bare cell having a generally rectangular prismatic shape;
a protection circuit board having a generally rectangular shape disposed on an upper surface of the bare cell; and
a lead plate disposed at each end of the generally rectangular protection circuit board to connect the protection circuit board with the bare cell,
wherein each lead plate comprises:
a substrate fixing part fixed to the protection circuit board,
a bare cell fixing part fixed to the bare cell, and
a connection part to connect the substrate fixing part and the bare cell fixing part,
wherein the substrate fixing part and the bare cell fixing part are disposed in opposite directions away from the connection part, and the bare cell fixing part is disposed toward a periphery of the bare cell,
wherein each lead plate is disposed such that the connection parts are between the protection circuit board and the upper surface of the bare cell.

18. The rechargeable battery of claim 17, wherein each connection part of each lead plate is disposed to align respectively with the each end of the generally rectangular protection circuit board.

19. The rechargeable battery of claim 17, wherein a length of each connection part is sufficient to provide a space between the upper surface of the bare cell and the protection circuit board.

20. The rechargeable battery of claim 17, wherein each substrate fixing part is laser-welded to the protection circuit board, and the bare cell fixing part is laser-welded to the upper surface of the bare cell.
